(19) United States
(12) Patent Application Publication
(10) Pub. No.: US 2024/0275415 A1
(43) Pub. Date: Aug. 15, 2024

(54) METHODS AND APPARATUSES FOR AN AUTONOMOUSLY TUNABLE INTERFERENCE TRACKING FILTER

(71) Applicant: The Government of the United States, as represented by the Secretary of the Navy, Washington, DC (US)

(72) Inventors: Sanghoon Shin, Burke, VA (US); Hans Haucke, Accokeek, MD (US)

(21) Appl. No.: 18/441,922

(22) Filed: Feb. 14, 2024

Related U.S. Application Data
(60) Provisional application No. 63/445,504, filed on Feb. 14, 2023.

(51) Int. Cl. H04B 1/10; H04B 1/16

(52) U.S. Cl. CPC H04B 1/1036; H04B 1/1607

(57) ABSTRACT

Methods and apparatuses for attenuating an interferer signal are provided. The apparatus includes a tunable filter and an autonomous tracking control circuit. The tunable filter is constructed to receive signals within a frequency bandwidth and includes a plurality of tunable bandpass filters with respective bandpass filter responses. The tunable filter has a band reject filter response that is dependent upon the bandpass filter responses. The autonomous tracking control circuit is constructed to track an interferer signal within the frequency bandwidth and perform voltage control on the plurality of tunable bandpass filters to alter the band reject filter response of the tunable filter such that the interferer signal is attenuated in an output of the tunable filter.

### CROSS-REFERENCE TO RELATED APPLICATIONS

This application claims priority to U.S. patent application No. 63/445,504 filed Feb. 14, 2023, the contents of which are incorporated by referenced herein in their entirety.

### BACKGROUND

### Field of the Invention

The present application relates generally to methods and apparatuses for an autonomously tunable interference tracking filter.

### Description of related art

It goes without saying that radio communications is an essential part of life in the 21^{st} century. A direct result of the proliferation of radio communications over the past decades is that the radio spectrum has become extremely crowded. This presents a problem to radio communications. If one is interested in receiving a particular signal (a signal of interest (SOI)) at a particular frequency, the presence of other signals with similar frequencies can present a challenge to receiving the SOI. This is especially true if the other signals have a particular strong amplitude relative to the SOI.

This problem is compounded in situations where there are multiple wireless system technologies allocated close together in the electromagnetic spectrum. Interference may be produced by a system located physically adjacent or spectrally close to the user's system. This is especially problematic in a setting where multiple high-powered systems are physically co-located, thus creating unwanted user interference. One conventional approach to mitigate these challenges is a switchable filter bank (SFB) which acts as a pre-selective filter to reconfigure the receiving communication bands with fast solid-state switching speed. One of the advantages of this approach is that it can implemented fairly easily. However, the rejection band of the SFB is limited by the fixed instantaneous bandwidth of the selected filter, which results in a limited system even if the undesired signal is restricted to a narrow band. Continuously tunable filters can be used to filter out unwanted signals, but their performance is limited by the tuning frequency range, slow tuning speed, and high loss due to low quality factor components. In addition, both of these approaches are ineffective when the incoming frequency information of the interferer is unknown. Accordingly, it would be preferable to have a system that can mitigate these problems.

### SUMMARY OF THE INVENTION

One or more the above limitations may be diminished by structures and methods described herein.

In one embodiment, an apparatus for attenuating an interferer signal is provided. The apparatus includes a tunable filter and an autonomous tracking control circuit. The tunable filter is constructed to receive signals within a frequency bandwidth and includes a plurality of tunable bandpass filters with respective bandpass filter responses. The tunable filter has a band reject filter response that is dependent upon the bandpass filter responses. The autonomous tracking control circuit is constructed to track an interferer signal within the frequency bandwidth and perform voltage control on the plurality of tunable bandpass filters to alter the band reject filter response of the tunable filter such that the interferer signal is attenuated in an output of the tunable filter.

### BRIEF DESCRIPTION OF THE DRAWINGS

The teachings claimed and/or described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic illustration of a reflective-mode tunable filter and an autonomous tracking control circuit according to one embodiment;

FIG. 2 is a schematic illustration of the reflective-mode tunable filter according to one embodiment;

FIG. 3 is a schematic illustration of an autonomous tracking control circuit 200 according to one embodiment;

FIG. 4 is another schematic illustration of a reflective-mode tunable filter and an autonomous tracking control circuit according to one embodiment;

FIG. 5A is a graph of filter responses according to one embodiment;

FIG. 5B is a graph of filter responses according to another embodiment;

FIG. 6A is a graph of filter responses in a steady-state mode;

FIG. 6B is a graph of filter responses when an interferer signal has shifted in frequency and before the filter responses have been altered to account for the shift in frequency; and

FIG. 7 is a graph of an evolving band reject filter response for a tunable filter as an interferer signal increases in frequency.

Different ones of the Figures may have at least some reference numerals that are the same in order to identify the same components, although a detailed description of each such component may not be provided below with respect to each Figure.

### DETAILED DESCRIPTION OF THE PREFERRED EMBODIMENTS

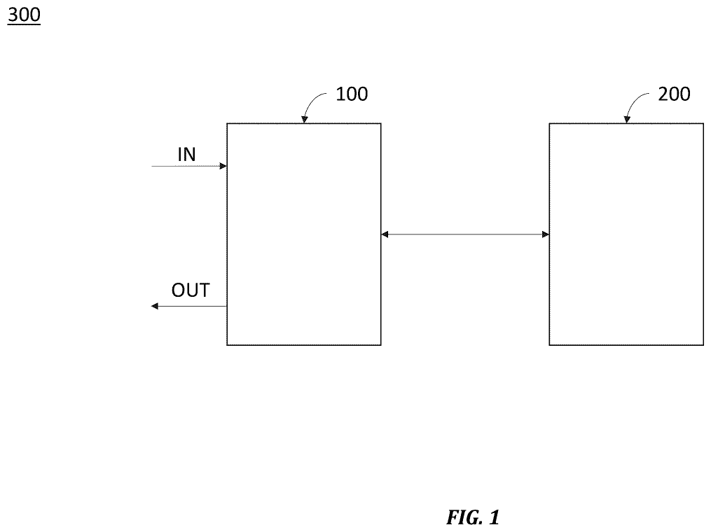

In accordance with example aspects described herein are autonomously tunable interference tracking filters (AITF). FIG. 1 is a schematic view of an AITF 300 comprising a reflective-mode tunable filter 100 and an autonomous tracking control circuit 200. The reflective-mode tunable filter 100 is constructed to receive a signal through an input (“IN”) and return a filtered signal through an output (“OUT”) where an interferer signal present in the input is attenuated in the output. As described in further detail below, the reflective mode tunable filter 100 has a band-reject response that causes a certain portion of the input signal to be attenuated or substantially eliminated. The frequency range of the band-reject response is controlled by the autonomous tracking control circuit 200. As explained in greater detail below, the autonomous tracking control circuit 200 operates to detect the presence of an interferer signal above a certain threshold and then performs voltage control on tunable bandpass filters in the reflective-mode tunable filter 100 that alter the band reject response of filter 100 to attenuate the interferer signal. Having described the general operation of the AITF 300, attention will now be directed to the details of filter 100 and control circuit 200 according to exemplary embodiments.

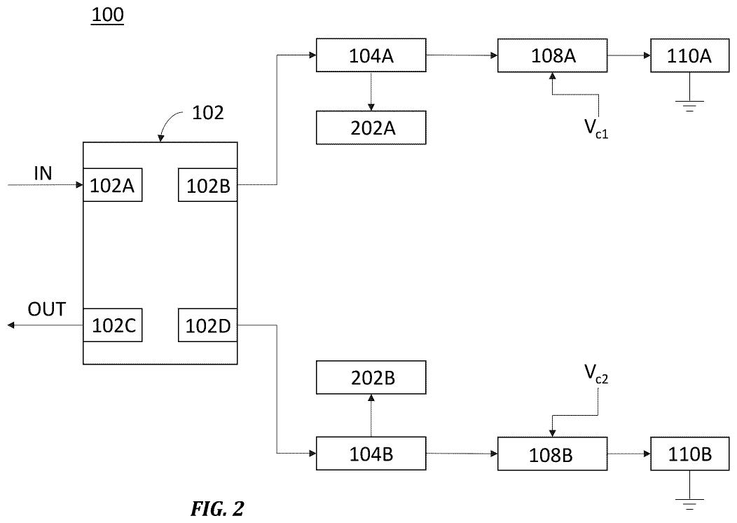

FIG. 2 is a schematic illustration of an exemplary reflective-mode tunable filter 100 according to one embodiment. One or more signals within a certain frequency bandwidth are received at the input port 102A of a wideband quadrature hybrid coupler 102. While multiple signals at different frequencies may be received, for simplicity and ease of explanation such signals will be described as an input signal in this description. As one of ordinary skill will appreciate, the wideband quadrature hybrid coupler 102 splits the input signal into two signals of approximately equal magnitude but out of phase by 90°. The split signals are then directed to the coupled port arms 102B and 102D of the coupler 102 and from there provided to directional couplers 104A and 104B, respectively. As one of ordinary skill will appreciate, a directional coupler couples a portion of an input signal onto another transmitting element to generate a copy of the input signal in the other transmitting element. This is sometimes referred to as splitting the signal into two, but not necessarily equal, signals. In this instance, directional coupler 104A sends one signal to sensing filter 202A, and the other signal to a tunable bandpass filter 108A. Similarly, directional coupler 104B sends one signal to a sensing filter 202B and the other signal to tunable bandpass filter 108B. The bandpass filters 108A and 108B are terminated, in one embodiment, with matching loads 110A and 110B. A matched load is one whose input impedance is equal to, or substantially equal to, the output impedance of the circuit. The matching loads are connected to ground. As discussed below, the tunable bandpass filters 108A and 108B may be tuned to alter their respective filter responses by applying different voltages to them. In an exemplary embodiment, bandpass filters 108A and 108B may be Yttrium-Iron-Garnet (YIG) electromagnetically tunable filters, such as the MLFP series of filters produced by Micro Lambda Wireless, Inc. Having described the structure of the reflective-mode tunable filter 100, attention will now be directed to its operation by reference to an example operation.

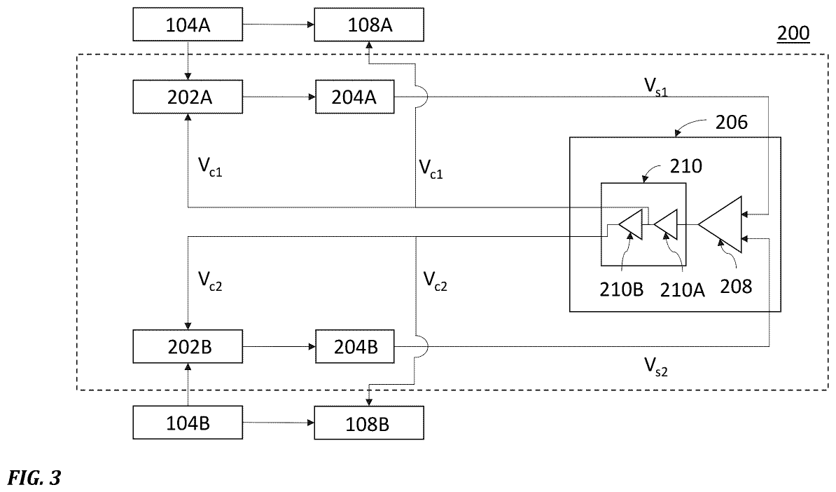

Let's assume that multiple signals across different frequency ranges are received at the input port 102A of the wideband quadrature hybrid coupler 102 and that one of those signals is a high power interferer signal above a certain threshold (e.g., 0˜15 dBm). Through the architecture described above, those received signals are directed to bandpass filters 108A and 108B whose passbands are determined by their respective filter responses. If the high power interferer signal occurs within the passband of these bandpass filters 108A and 108B, then the interferer signal goes through the bandpass filters 108A and 108B and are dissipated in the matched loads 110A and 110B. More specifically, any received signals within the passband frequencies of the bandpass filters 108A and 108B pass through those filters and are dissipated through the matched loads 110A and 110B. Since those signals are dissipated in the matched loads 110A and 110B they do come back into the wideband quadrature hybrid coupler 102. However, signals whose frequencies lie outside of the passbands of bandpass filters 108A and 108B, also known as the stopband of the bandpass filters 108A and 108B, will be reflected back into the wideband quadrature hybrid coupler 102 and combined at the output port 102C (isolation port). Therefore, only signals within the passbands of both terminated bandpass filters 108A and 108B are attenuated. As a result, the performance of the reflective-mode tunable filter 100 will be a non-reflective (absorptive) band-stop response even though bandpass filters are used. This is due to the nature of a quadrature hybrid coupler. With structure shown in FIG. 2, the transfer function of the reflected signals is reversed at the output port 102C of the wideband quadrature hybrid coupler 102. In other words, the return loss of bandpass filters 108A and 108B appears as a band-reject response or insertion loss for filter 100. Therefore, a monotonic sharp band-reject response is obtained even with low-order bandpass filters. Having described the structure and operation of the reflective-mode tunable filter 100, attention will now be directed to the autonomous tracking control circuit 200, shown in FIG. 3.

As described above, the reflective-mode tunable filter 100 is capable of eliminating an interferer signal, or signals, that occurs within the passband of the bandpass filters 108A and 108B. However, as described above, one typically does not know at what frequency, or frequencies, interferer signals will present themselves. The autonomous tracking control circuit 200, described below and shown in FIG. 3, is constructed to identify interferer signals and to adjust the reflective-mode tunable filter 100 to substantially mitigate the same.

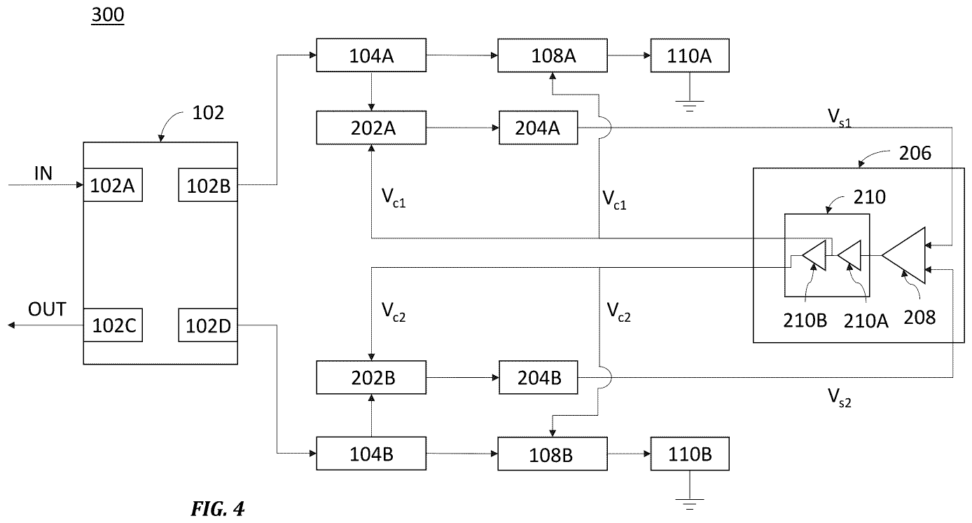

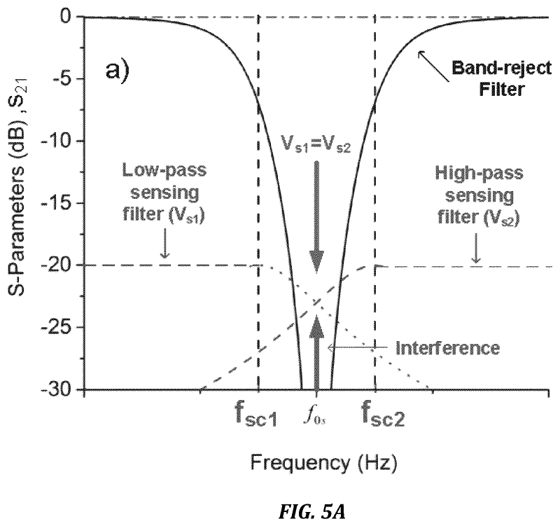

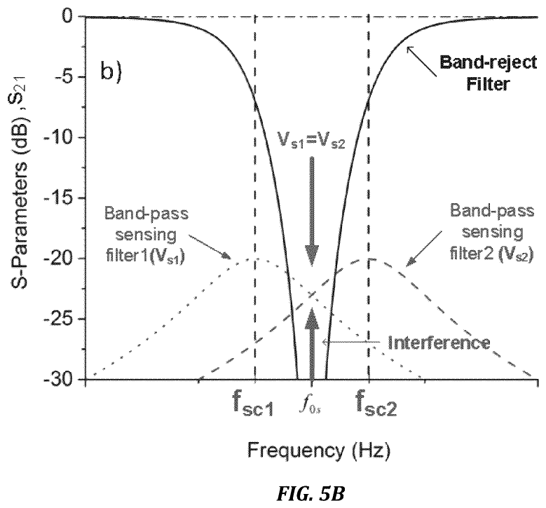

FIG. 3 is a schematic diagram of the autonomous tracking control circuit 200 according to one embodiment. As discussed above, directional couplers 104A and 104B send a portion of the signals they receive from coupler 102 to sensing filters 202A and 202B, respectively. In one embodiment, the sensing filters 202A and 202B could be a low-pass filter and a high-pass filter. So, for example, filter 202A could be a low-pass filter and filter 202B could be a high-pass filter, or vice versa. An exemplary operation of an AITF 300 in a steady-state mode of operation where the sensing filters 202A and 202B are low-pass and high-pass filters is shown in FIG. 5A. In another embodiment, sensing filters 202A and 202B could be bandpass filters, and an exemplary operation of an AITF 300 in a steady-state mode of operation where sensing filters 202A and 202B are bandpass filters is shown in FIG. 5B. The filtered signals output from sensing filters 202A and 202B are provided to detectors 204A and 204B, respectively. In an exemplary embodiment, detectors 204A and 204B are photodiodes. In another exemplary embodiments, detectors 204A and 204B may be DC758A RF detectors. Detectors 204A and 204B convert the filtered signals into voltages that are then provided to an op-amp circuit 208. Op-amp circuit 208 is part of a tracking control circuit 206 that is constructed to perform voltage control on, by outputting voltages to, sensing filters 202A and 202B and bandpass filters 108A and 108B. In addition to the op-amp circuit 208, the tracking control circuit 206 also includes an integrator circuit 210. Op-amp circuit 208 outputs a positive or negative voltage depending on the voltage offset between the two detectors 204A and 204B which are provided to the inputs of the op-amp circuit 208. The voltage from the op-amp circuit 208 is then provided to an integrator circuit 210. In a preferred embodiment, the integrator circuit may include an integrator 210A that receives the output from op-amp circuit 208 and then produces an output which is proportional to the amplitude and duration of the voltage output from op-amp circuit 208. The output of integrator 210A is the first voltage control signal V_{c1} which sets the voltages of sensing filter 202A and bandpass filter 108A. The output of integrator 210A is also provided to op-amp 210B which applies a voltage offset to generate a second voltage control signal V_{c2}. The voltage offset is dependent upon the difference in cutoff frequencies of sensing filters 202A and 202B. The voltage control signals V_{c1} and V_{c2} also determine the tuning voltage on each tunable bandpass filter 108A and 108B, as shown in FIG. 4. Since detectors 204A and 204B are coupled to the sensing filters 202A and 202B, respectively, the voltage response is frequency selective and has a peak at the passband if the sensing filters 202A and 202B are a combination of a low-pass filter and a high-pass filter (as illustrated in FIG. 5A), or the peak is at the center frequency of the resonator when the sensing filters 202A and 202B are a pair of bandpass filters (as illustrated in FIG. 5B). Having described the structure and operation of the autonomous tracking control circuit 200, as well as the reflective-mode tunable filter 100, attention is now directed to FIG. 4 which is a schematic diagram of the AITF 300 showing the combination of the reflective mode tunable filter 100 and the autonomous tracking control circuit 200 together.

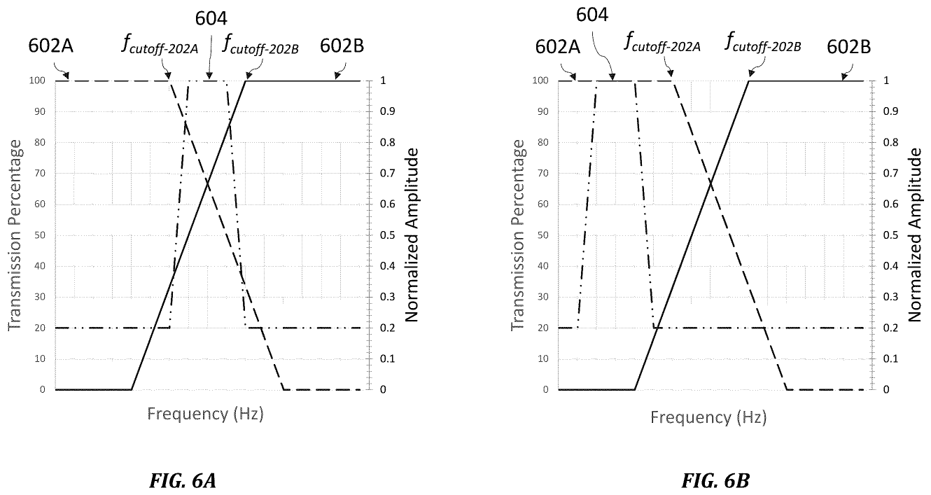

To even further illustrate the operation of AITF 300, let us consider a situation where the AITF 300 has reached a steady-state where the band reject response of the reflective-mode tunable filter 100 is centered on an interferer signal (as depicted in FIGS. 5A and 5B), but now the frequency of the interferer signal 604 changes such that, in frequency space, the interferer signal 604 shifts along the x-axis in FIGS. 5A and 5B, FIGS. 6A-B are illustrative.

FIG. 6A shows the filter responses 602A and 602B of sensing filters 202A and 202B, respectively, in an embodiment where the sensing filters 202A and 202B are implemented as a pair of low pass (e.g., filter 202A) and high pass (e.g., filter 202B) filters. As one of ordinary skill in the art will appreciate, an ideal low pass filter will allow all frequencies below a certain frequency (also referred to as the cutoff frequency) to pass but block frequencies above the cutoff frequency. Similarly, an ideal high pass filter will allow all frequencies above the cutoff frequency to pass but block all frequencies below the cutoff frequency. The cutoff frequency may not be a discrete “on”/“off” point in the frequency spectrum. In the embodiment shown in FIG. 6A, sensing filters 202A and 202B have transition regions over which their respective transition percentages change from 100%-0% or vice versa. Also shown in FIG. 6A, is the interferer signal 604 whose amplitude has been normalized for purposes of this discussion but which is over the threshold for adjusting the filter responses of AITF 300 (e.g., 0-15 dBm). In steady state operation in the presence of an interferer signal 604, the interferer signal 604 is centered in frequency space at the point where the filter responses for sensing filters 202A and 202B cross by virtue of the fact that in this mode of operation the voltage output from the detectors 204A and 204B is substantially the same because the filter responses of sensing filters 202A and 202B block a substantially similar amount of the interferer signal. This means the voltage difference between the inputs to op-amp circuit 208 is approximately zero, which causes the autonomous control circuit 200 not adjust the filter responses of sensing filters 202A and 202B, or the filter responses of bandpass filters 108A and 108B. However, in FIG. 6B, the interferer signal 604 has shifted to a lower frequency. In this case, the interferer signal 604 is now substantially below the cutoff frequency of low-pass sensing filter 202A (f_{cutoff-202A}) meaning most, if not all, of the signal is passed through low-pass sensing filter 202A. Similarly, the interferer signal 604 is now well below the frequency cutoff of high-pass sensing filter 202B (f_{cutoff-202B}) which means most, if not all, of the interferer signal is block by high-pass sensing filter 202B. The result of this is that the output of detector 204A will be substantially greater than the output of detector 204B, and thus the voltage output by op-amp circuit 208 will be substantially greater than in a steady state mode. This causes integrator circuit 210 to supply voltages to sensing filters 202A and 202B, respectively, which in turn causes each of the sensing filters 202A and 202B to adjust their cutoff frequency downwards until each filter again block a substantially similar amount of the interferer signal 200 which returns AITF 300 to a steady state mode.

A similar operation occurs when sensing filters 202A and 202B are implemented as bandpass filters. In that embodiment, when AITF 300 is operating in a steady-state mode, bandpass sensing filters 202A and 202B pass approximately equal amounts of the interferer signal 604 which in turns causes the outputs of detectors 204A and 204B to be substantially similar. This means the voltages applied to the inputs of op-amp circuit 208 are approximately equal and thus the output of the autonomous control circuit 200 does not result in a change in filter response of bandpass sensing filters 202A and 202B. However, if the interferer signal shifts in the frequency space to a lower or higher frequency, then the output of photodetectors 204A and 204B are not substantially the same. This will cause the voltages applied to op-amp circuit 208 to be dissimilar and result in integrator circuit 210 supplying voltages to sensing filters 202A and 202B, respectively, which cause each of the sensing filters 202A and 202B to adjust their cutoff frequency upwards or downwards, depending upon the inputs to op-amp 208, until each sensing filter 202A and 202B again block a substantially similar amount of the interferer signal which returns AITF 300 to a steady state mode. One of the advantages of the structure of AITF 300 is that components thereof offer a fast response time relative to conventional approaches. As shown in FIG. 4, the voltages supplied by integrator 210 are also provided to bandpass filters 108A and 108B. These voltages adjust the passbands of those filters so that the band reject response of the reflective-mode tunable filter 100 is now centered upon the shifted interferer signal.

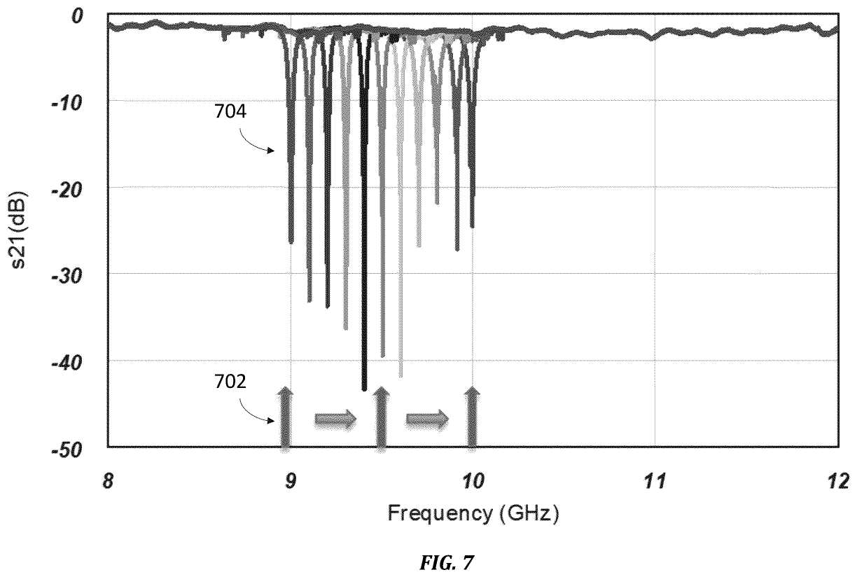

FIG. 7 is a graph illustrating the ability of AITF 300 tracking the interferer signal in frequency space. As shown in FIG. 7, an interferer signal 702 is present at approximately 9.0 GHz. The band response 704 of AITF 300 is also shown depicted and is initially centered at 9.0 GHz as well. As the interferer signal 702 shifts upwards to a higher frequency, namely to 9.5 GHz and then 10 GHz, the band response 704 of AITF 300 shifts as well eventually entering a steady operation mode as the interferer signal remains at 10 GHz. The band response 704 of AITF 300 shows approximately 40 MHz of rejection bandwidth with roughly 30- to 40-dB attenuation.

While various example embodiments of the invention have been described above, it should be understood that they have been presented by way of example, and not limitation. It is apparent to persons skilled in the relevant art(s) that various changes in form and detail can be made therein. Thus, the disclosure should not be limited by any of the above described example embodiments, but should be defined only in accordance with the following claims and their equivalents.

In addition, it should be understood that the figures are presented for example purposes only. The architecture of the example embodiments presented herein is sufficiently flexible and configurable, such that it may be utilized and navigated in ways other than that shown in the accompanying figures.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

What is claimed is:

1. An apparatus for attenuating an interferer signal, comprising:
a tunable filter constructed to receive signals within a frequency bandwidth, wherein the tunable filter includes a plurality of tunable bandpass filters with respective bandpass filter responses, and wherein the tunable filter has a band reject filter response dependent upon the bandpass filter responses; and
an autonomous tracking control circuit constructed to track an interferer signal within the frequency bandwidth and perform voltage control on the plurality of tunable bandpass filters to alter the band reject filter response of the tunable filter such that the interferer signal is attenuated in an output of the tunable filter.
